(19) United States
(12) Patent Application Publication
(10) Pub. No.: US 2004/0124244 A1
(43) Pub. Date: Jul. 1, 2004

(54) Card minimizer

(76) Inventor: Kevin Kenneth Rynn, Tampa, FL (US)

Correspondence Address: Kevin Kenneth Rynn, 40 Cedar Walk, #2218, Long Beach, CA, 90802, US

(21) Appl. No.: 10/412,404

(22) Filed: Apr. 13, 2003

Related U.S. Application Data
(60) Provisional application No. 60/436,802, filed on Dec. 27, 2002.

(51) Int. Cl. G06K 19/00

(52) U.S. Cl. 235/487

(57) ABSTRACT

The present invention provides a method of placing multiple bar code cards and or other data cards onto a single card. This method is achieved by placing stickers that have a bar code and or other data on them and placing the stickers on the edges of the face on both sides of the card. The stickers can be arranged along both sides of the card to allow up to eight different bar codes and or other data on one card and still allow the user to scan each bar code and or other data through a card reader separately.

### CROSS REFERENCE TO RELATED APPLICATIONS

This application claims the benefit of provisional patent application Ser. Nr. 60/436,802 filed Dec. 27, 2002

### STATEMENT REGARDING FEDERALLY SPONSERED RESEARCH OR DEVELOPMENT

Not applicable.

### REFERANCE TO SEQUENCE LISTING, A TABLE, OR A COMPUTER PROGRAM LISTING COMPACT DISK APPENDIX

Not applicable.

### BACKGROUND OF THE INVENTION

This invention relates generally to improvements for bar code and or other data cards. In today's marketplace there has been a proliferation in the use of various types of membership cards, discount cards and other types of identification cards. For example, an average individual is likely to carry several grocery store discount cards, video store membership cards and various other identification cards. Each of these cards typically incorporates a bar code and or other data. Although the use of these cards allow for easy and efficient electronic recognition of the cardholder, the number of such cards quickly becomes cumbersome and many individuals find carrying the large number of cards inconvenient.

### BRIEF SUMMARY OF THE INVENTION

In accordance with invention, the Card Minimizer uses a method of placing multiple bar code and or other data cards onto a single card to consolidate information from multiple bar code and or other data cards onto a single card.

### BRIEF DESCRIPTION OF THE SEVERAL VIEWS OF THE DRAWING

FIG. 1 is the front view of the card.

FIG. 2 is the rear view of the card.

### DETAILED DESCRIPTION OF THE INVENTION

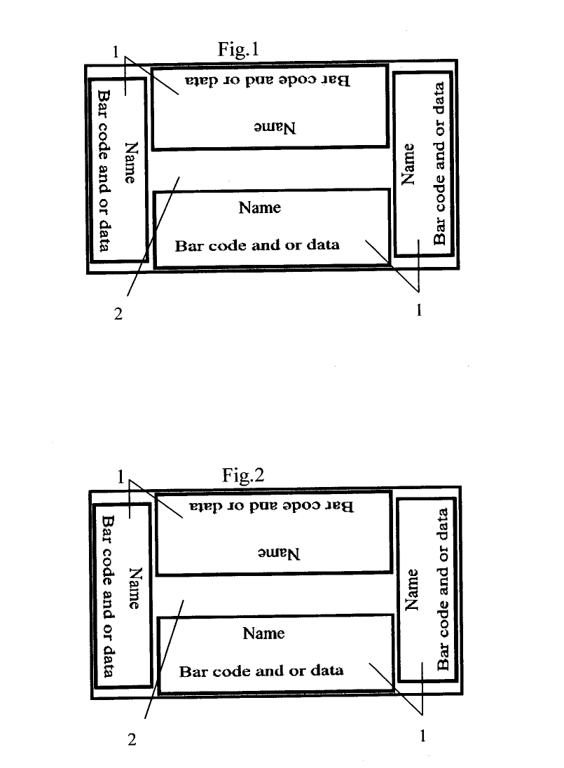

The stickers (1) are placed along the face of both sides (FIGS. 1, 2) of the card (2). The stickers (1) are arranged along both sides of the card (2) to allow up to eight different bar codes and or other data on one card and still allow the user to scan each bar code and or other data through a card reader. More than eight bar code and or other data can be placed on the card if desired by way of using smaller stickers (1) on to the card (2). An alternate way of placing the bar codes and or other data on the card is to pre print the multiple bar codes and or other data on to a blank card in place of the stickers.

Claims

1. I claim a method of placing multiple bar codes and or other data cards onto a single card by placing stickers that have the bar code and or other data on them and placing them on the face of both sides of a card.

2. A method as in claim 1 wherein the bar code and or other data are pre printed onto a blank card.

Abstract of the Disclosure

The present invention provides a method of placing multiple bar code cards and or other data cards onto a single card. This method is achieved by placing stickers that have a bar code and or other data on them and placing the stickers on the edges of the face on both sides of the card. The stickers can be arranged along both sides of the card to allow up to eight different bar codes and or other data on one card and still allow the user to scan each bar code and or other data through a card reader separately.

1. I claim a method of placing multiple bar codes and or other data cards onto a single card by placing stickers that have the bar code and or other data on them and placing them on the face of both sides of a card.

2. A method as in claim 1 wherein the bar code and or other data are pre printed onto a blank card.
